(19) United States
(12) Patent Application Publication
(10) Pub. No.: US 2014/0157060 A1
(43) Pub. Date: Jun. 5, 2014

(54) COMPUTING DEVICE TESTING SYSTEM AND METHOD

(71) Applicants: Hon Hai Precision Industry Co., Ltd., New Taipei (TW); Hong Fu Jin Precision Industry (ShenZhen) Co., Ltd., Shenzhen (CN)

(72) Inventor: MING-XIANG HU, Shenzhen (CN)

(73) Assignees: Hon Hai Precision Industry Co., Ltd., New Taipei (TW); Hong Fu Jin Precision Industry (ShenZhen) Co., Ltd., Shenzhen (CN)

(21) Appl. No.: 14/034,548

(22) Filed: Sep. 23, 2013

(30) Foreign Application Priority Data
Nov. 30, 2012 (CN) 2012105030678

(51) Int. Cl. G06F 11/26

(52) U.S. Cl. CPC G06F 11/261
USPC 714/45

(57) ABSTRACT

In a computing device testing method, a virtual network terminal and a first communication interface are created in a computing device. A second communication interface is created in a control computer. The first communication interface and the second communication interface is binded to each other. A communication connection between the control computer and the computing device is established. Input and output information of a test program of the computing device is directed to the virtual network terminal. In response to a control command, the computing device executes the test program in the virtual network terminal. The control computer receives input information from an input device of the control computer, sends the input information to the test program. The computing device sends output information generated by the test program to the control computer. The output information is displayed on a display device of the control computer.

### BACKGROUND

1. Technical Field

Embodiments of the present disclosure relate to test systems and methods, and particularly to a computing device testing system and method.

2. Description of Related Art

A rack server is a computer dedicated as a server and designed to be installed in a framework called a rack. A single rack may contain a number of rack servers stacked one above the other to minimize required space. When testing a rack server, a user directly connects I/O devices (e.g., mouse, keyboard, and display) to the rack servers. However, it is inconvenient to directly connect I/O devices to each rack server in the rack. In addition, the use of multiple I/O devices will increase test cost.

### BRIEF DESCRIPTION OF THE DRAWINGS

FIG. 1 is a block diagram of one embodiment of a computing device testing system.

FIG. 2 is a block diagram of one embodiment of function modules of a first test unit in FIG. 1.

FIG. 3 is a block diagram of one embodiment of function modules of a second test unit in FIG. 1.

FIG. 4 is a flowchart of one embodiment of a computing device testing method using the system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of computer program instructions, written in a programming language, such as, JAVA, C, or assembly. One or more computer program instructions in the modules may be embedded in firmware, such as in an erasable programmable read only memory (EPROM). The modules described herein may be implemented as either computer program and/or hardware modules and may be stored in any type of non-transitory computer-readable medium or other storage device. Some non-limiting examples of non-transitory computer-readable media include CDs, DVDs, BLU-RAY, flash memory, and hard drive drives.

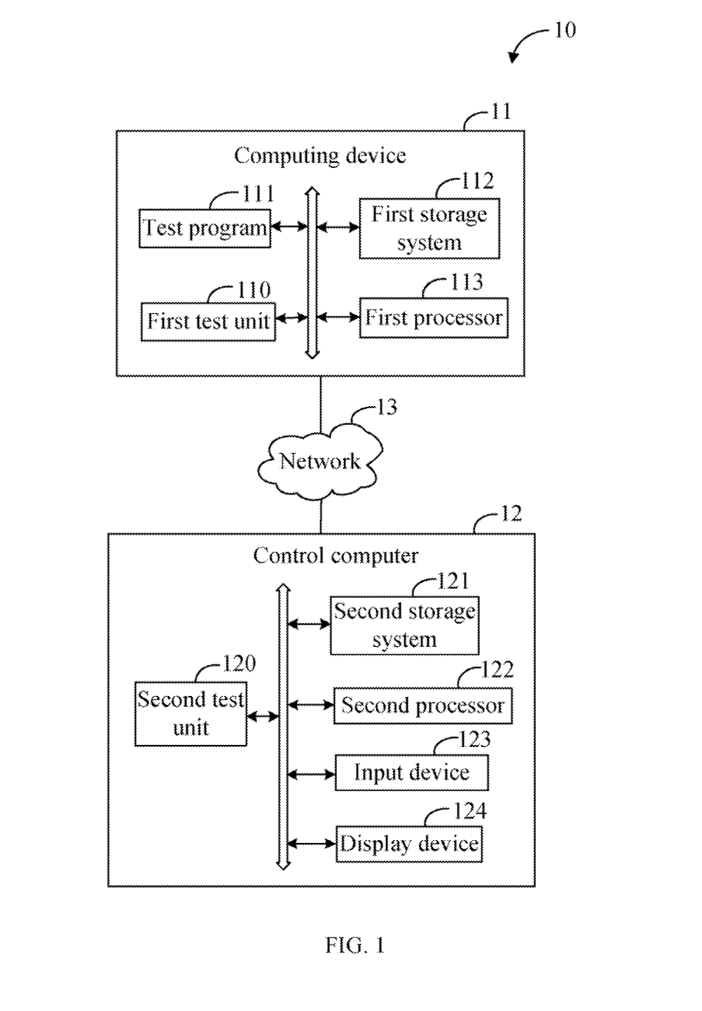

FIG. 1 is a block diagram of one embodiment of a computing device testing system 10. The computing device testing system 10 includes at least one computing device 11 (only one shown) and a control computer 12. The computing device 11 is connected to the control computer 12 through a network 13. The computing device testing system 10 uses I/O devices of the control computer 12 to test the computing device 11 without any I/O devices directly connected to the computing device 11. The computing device 11 may be a rack server or a blade server. The network 13 may be a public network or a private network.

In this embodiment, the computing device 11 includes a first test unit 110, a test program 111, a first storage system 112, and a first processor 113. The control computer 12 includes a second test unit 120, a second storage system 121, a second processor 122, an input device 123, and a display device 124. The first storage system 112 and the second storage system 121 may be dedicated memories, such as EPROMs, hard disk drives (HDDs), or flash memories. In some embodiments, the first storage system 112 and the second storage system 121 may be external storage devices, such as external hard disks, storage cards, or data storage mediums.

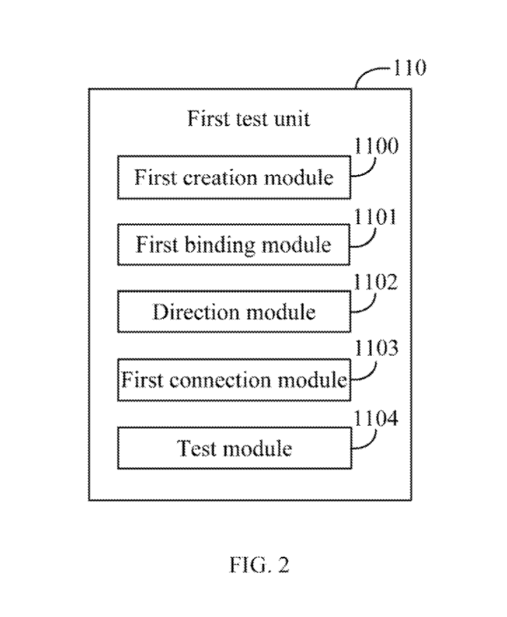

FIG. 2 is a block diagram of one embodiment of function modules of the first test unit 110 in FIG. 1. The first test unit 110 includes a first creation module 1100, a first binding module 1101, a direction module 1102, a first connection module 1103, and a test module 1104. The modules 1100-1104 may comprise computerized code in the form of one or more programs that are stored in the first storage system 112. The computerized code includes instructions that are executed by the first processor 113.

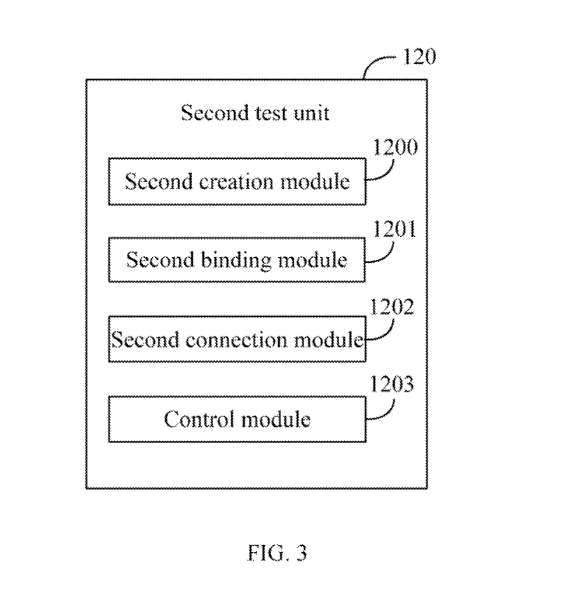

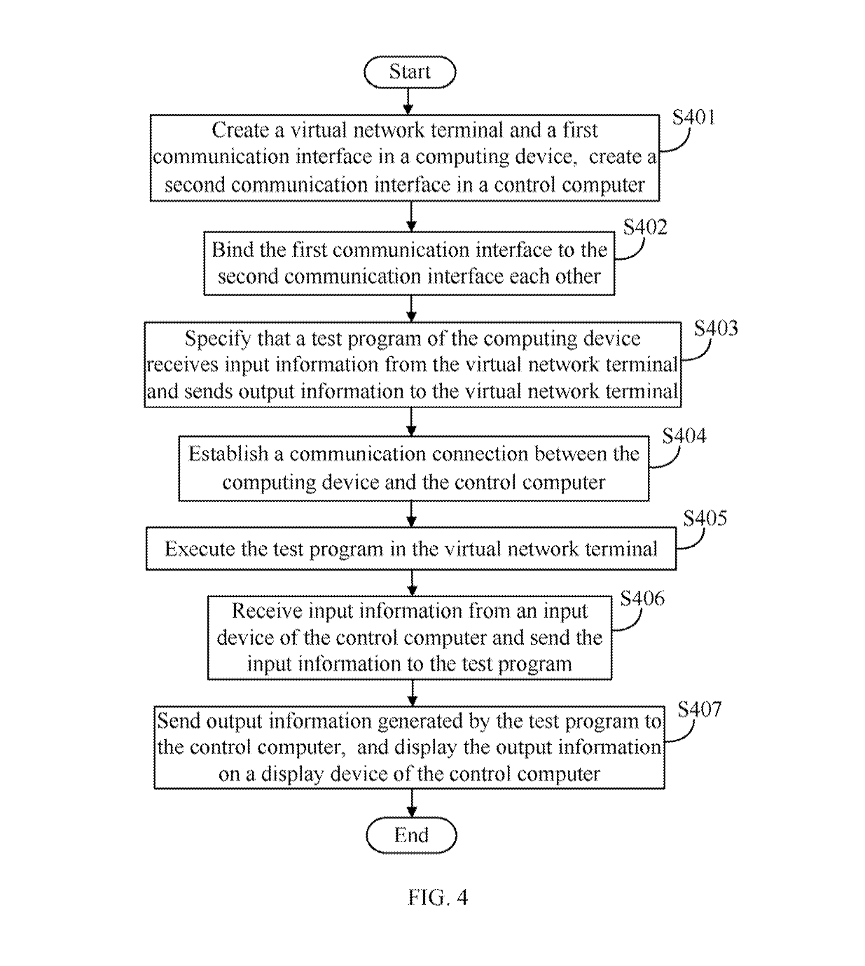

FIG. 3 is a block diagram of one embodiment of function modules of the second test unit 120 in FIG. 1. The second test unit 120 includes a second creation module 1200, a second binding module 1201, a second connection module 1202, and a control module 1203. The modules 1200-1203 may comprise computerized code in the form of one or more programs that are stored in the second storage system 121. The computerized code includes instructions that are executed by the second processor 122. A detailed description of the functions of the modules 1100-1104 and 1200-1203 is given in reference to FIG. 4.

FIG. 4 is a flowchart of one embodiment of a computing device testing method using the system 10 of FIG. 1. Depending on the embodiment, additional steps may be added, others removed, and the ordering of the steps may be changed.

In step S401, the first creation module 1100 creates a virtual network terminal and a first communication interface in the computing device 11. The second creation module 1200 creates a second communication interface in the control computer 12. The virtual network terminal is used as a network device to communicate with the control computer 12. In one embodiment, the first creation module 1100 creates the virtual network terminal in a kernel of an operating system of the computing device 11. The first communication interface and the second communication interface may be network sockets, which are used to communicate between the computing device 11 and the control computer 12. A network socket is an endpoint of an inter-process communication flow across a computer network.

In step S402, the first binding module 1101 binds the first communication interface to the second communication interface. The second binding module 1201 binds the second communication interface to the first communication interface. In one embodiment, communication parameters of each of the first communication interface and the second communication interface include a destination IP address, a source port number, and a destination port number. The first binding module 1101 sets the destination IP address of the first communication interface as an IP address of the control computer 12, and sets the destination port number of the first communication interface as the source port number of the second communication interface. The second binding module 1201 sets the destination IP address of the second communication interface as an IP address of the computing device 11, and sets the destination port number of the second communication interface as the source port number of the first communication interface.

In step S403, the direction module 1102 specifies that the test program 111 receives input information from the virtual network terminal and sends output information to the virtual network terminal. In this embodiment, the direction module 1102 further specifies that the computing device 11 sends boot information of the computing device 11 to the virtual network terminal. Therefore, if the computing device 11 fails to be booted, the boot information is outputted to the control computer 12 via the virtual network terminal, allowing the control computer 12 to diagnose boot errors in the computing device 11.

In step S404, the first connection module 1103 and the second connection module 1202 establishes a communication connection between the computing device 11 and the control computer 12 via the first communication interface and the second communication interface. In one embodiment, the first connection module 1103 sends a connection request to the control computer 12 via the first communication interface. In response to the connection request, the second connection module 1202 sends the communication parameters of the second communication interface to the computing device 11 via the second communication interface. The first connection module 1103 verifies the communication parameters of the second communication interface. If the communication parameters of the second communication interface are correct, the first connection module 1103 establishes the communication connection to the control computer 12.

In step S405, the control module 1203 sends a control command to the computing device 11. The test module 1104 receives the control command from the control computer 12. In response to the control command, the test module 1104 executes the test program 111 in the virtual network terminal to test the computing device 10.

In step S406, the control module 1203 receives input information required by the test program 111 from the input device 123 and sends the input information to the virtual network terminal The test module 1104 receives the input information from the virtual network terminal and passes the input information to the test program 111.

In step S407, the test module 1104 sends output information generated by the test program 111 to the virtual network terminal. The control module 1203 receives the output information from the virtual network terminal and displays the output information on the display device 124.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
at least one processor; and
a storage system storing a test program and a plurality of instructions, when executed by the at least one processor, causing the at least one processor to perform operations comprising:
creating a virtual network terminal and a first communication interface in the computing device;
binding the first communication interface to a second communication interface of a control computer connected to the computing device;
directing input and output of the test program to the virtual network terminal;
establishing a communication connection between the computing device and the control computer via the first communication interface;
receiving a control command from the control computer, and executing the test program in the virtual network terminal to test the computing device in response to the control command;
receiving input information required by the test program from the virtual network terminal, and passing the input information to the test program, wherein the input information is received from an input device of the control computer; and
sending output information generated by the test program to the virtual network terminal, wherein the output information is sent to the control computer and displayed on a display device of the control computer.

2. The computing device of claim 1, wherein the first communication interface and the second communication interface are network sockets.

3. The computing device of claim 1, wherein the virtual network terminal is created in a kernel of an operating system of the computing device.

4. The computing device of claim 3, wherein boot information of the computing device is sent to the virtual network terminal.

5. A control computer, comprising:
an input device;
a display device;
at least one processor; and
a storage system storing a plurality of instructions, when executed by the at least one processor, causing the at least one processor to perform operations comprising:
creating a second communication interface in the control computer;
binding the second communication interface to a first communication interface of a computing device connected to the control computer;
establishing a communication connection between the control computer and the computing device via the second communication interface;
sending a control command to the computing device, causing the computing device to execute a test program in a virtual network terminal of the computing device to test the computing device;
receiving input information required by the test program from the input device, and sending the input information to the virtual network terminal of the computing device, wherein the input information is passed from the virtual network terminal to the test program; and
receiving output information generated by the test program from the virtual network terminal and displaying the output information on the display device.

6. The control computer of claim 5, wherein the first communication interface and the second communication interface are network sockets.

7. The control computer of claim 5, wherein the virtual network terminal is created in a kernel of an operating system of the computing device.

8. A computing device testing method being executed by a processor of a computing device, the method comprising:
creating a virtual network terminal and a first communication interface in the computing device;
binding the first communication interface to a second communication interface of a control computer connected to the computing device;
specifying that the test program receives input information from the virtual network terminal and sends output information to the virtual network terminal;
establishing a communication connection between the computing device and the control computer via the first communication interface;
receiving a control command from the control computer, and executing the test program in the virtual network terminal to test the computing device in response to the control command;
receiving input information required by the test program from the virtual network terminal, and passing the input information to the test program, wherein the input information is received from an input device of the control computer; and
sending output information generated by the test program to the virtual network terminal, wherein the output information is sent to the control computer and displayed on a display device of the control computer.

9. The method of claim 8, wherein the first communication interface and the second communication interface are network sockets.

10. The method of claim 8, wherein the virtual network terminal is created in a kernel of an operating system of the computing device.

11. The method of claim 8, wherein boot information of the computing device is sent to the virtual network terminal.
